(19) United States
(12) Patent Application Publication
(10) Pub. No.: US 2007/0029019 A1
(43) Pub. Date: Feb. 8, 2007

(54) Ring Member for a Tire Chain, Especially a Protective Tire Chain, and Method for Producing a Tire Chain

(75) Inventors: Hansjorg Rieger, Aalen (DE); Johannes Werner Rieger, Aalen (DE); Zvonimir Bogdan, Abtsgemünd (DE)

Correspondence Address: GUDRUN E. HUCKETT DRAUDT, LONSSTR. 53, WUPPERTAL, 42289, DE

(73) Assignee: EISEN- UND DRAHTWERK ERLAU AG, Aalen (DE)

(21) Appl. No.: 11/456,586

(22) Filed: Jul. 11, 2006

(30) Foreign Application Priority Data
Jul. 28, 2005 (DE) 10 2005 036 720.8

(51) Int. Cl. B60C 27/00

(52) U.S. Cl. 152/222

(57) ABSTRACT

A ring member for a tire chain has a ring body having at least one flattened portion deviating from a circular shape at an outer side of the ring member. The tire chain made from such a ring member has also stay members engaging the ring members. The ring members are arranged such that the at least one flattened portion, respectively, extends at least approximately in a longitudinal chain direction.

The invention concerns a ring member for a tire chain, in particular, a protective tire chain, according to the preamble of claim 1 as well as a method for producing a tire chain according to the preamble of claim 20.

Ring members for tire chains are known whose ring body is continuously curved. Usually, stay members are inserted into the ring members and ensure traction of the tire chain. Tilting loads of the stay members depend inter alia on the angle at which they are arranged relative to the longitudinal chain direction within the tire chain.

It is an object of the invention to configure a ring member of the aforementioned kind as well as a method of the aforementioned kind in such a way that a simple manufacture is possible while a minimal loading of the chain members is ensured.

This object is solved in accordance with the present invention in connection with the ring member of the aforementioned kind by the characterizing features of claim 1 and in accordance with the present invention in connection with the method of the aforementioned kind by the characterizing features of claim 20.

In the ring member according to the invention, the ring body is provided at its outer side with a shape that deviates from a circular shape. This shape deviation is referred to in the following as flattened portion. The deviating shape can be plane but can also have a deviating, in particular, a substantially greater radius of curvature than the remaining part of the ring body. This shape of the ring body has the result that within a chain assembly the stay members inserted into the ring member can be positioned substantially steeper in the longitudinal chain direction when the tire chain is tensioned. For example, the angle between the longitudinal axes of neighboring stay members inserted into the same ring member can be smaller than 60 degrees, preferably it can be approximately 50 degrees. The stay members then have within the tire chain an optimal position with regard to tilting loads acting on them. As a result of the deviating shape of the ring body, the ring members that neighbor one another transversely to the longitudinal chain direction can have a smaller spacing than ring members whose ring body has a constant radius. Because of this smaller spacing of the ring members relative to one another, the pitch angle of the stay members can be small. Because of this small pitch angle the tilting load on the stay members is small also. In this way, the risk of damage to the stay members during the rugged use of protective tire chains is reduced. When the traction is to be increased, the stay members can be provided with an appropriate profile on their wear side.

The ring member can have a closed ring body. However, it is also possible to configure the ring member such that the ring body has outwardly bent ends that delimit an insertion opening for the chain members to be inserted and on which a closure part for closing the insertion opening is fastened.

In a further configuration according to the invention, the closure part is partially open transversely to the longitudinal direction of the ring body ends. In this way, it is possible to weld the closure part onto the ring body ends without the closure part having to be brought into a special, in particular, upright, position for the welding process. In known ring members, welding of the ring body ends is possible only from the end face of the closure part. Therefore, the closure part during manufacture of the tire chain must be brought first into an upright position in order for the welding step to take place. In the ring member according to the invention, the closure part is however laterally open so that welding of the ring body ends to the closure part is possible from the side.

In a further embodiment according to the invention, the ring body ends in the closure part are not connected about their entire circumference by means of the welding seam to the closure part. In this way it is possible to carry out welding of the ring body ends in the closure part only from one side. The closure part must then not be turned over so that the assembly of the tire chain is significantly simplified.

In the tire chain according to the invention, the ring members within the chain arrangement are arranged such that their flattened portions extend in the longitudinal chain direction. The stay members that are inserted into the ring members can then assume their optimal position when the chain is tensioned.

In the method according to the invention, the welding device is positioned at the closure part transversely to the side having the recess so that the welding device welds the ring body ends in the recess to the closure part while the ring member is lying flat.

Further features of the invention result from the additional claims, the description, and the drawings.

The invention will be explained in more detail with the aid of an embodiment illustrated in the drawings. It is shown in:

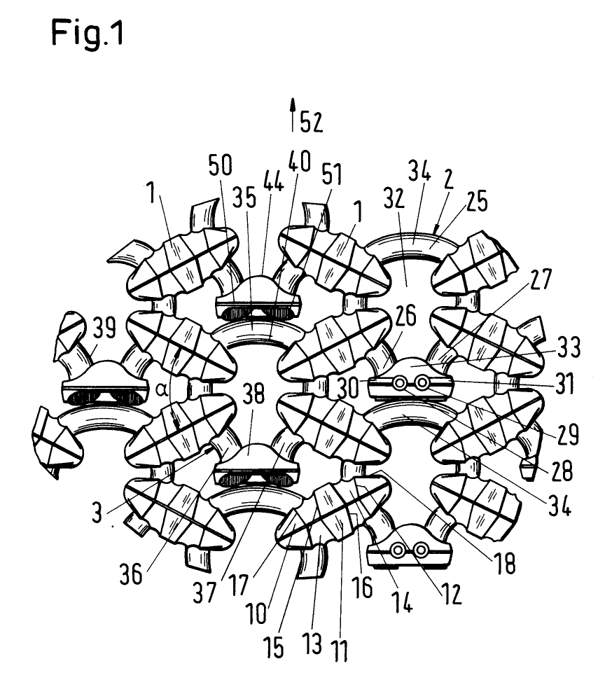

FIG. 1 a part of a protective tire chain with chain members according to the present invention in the new state;

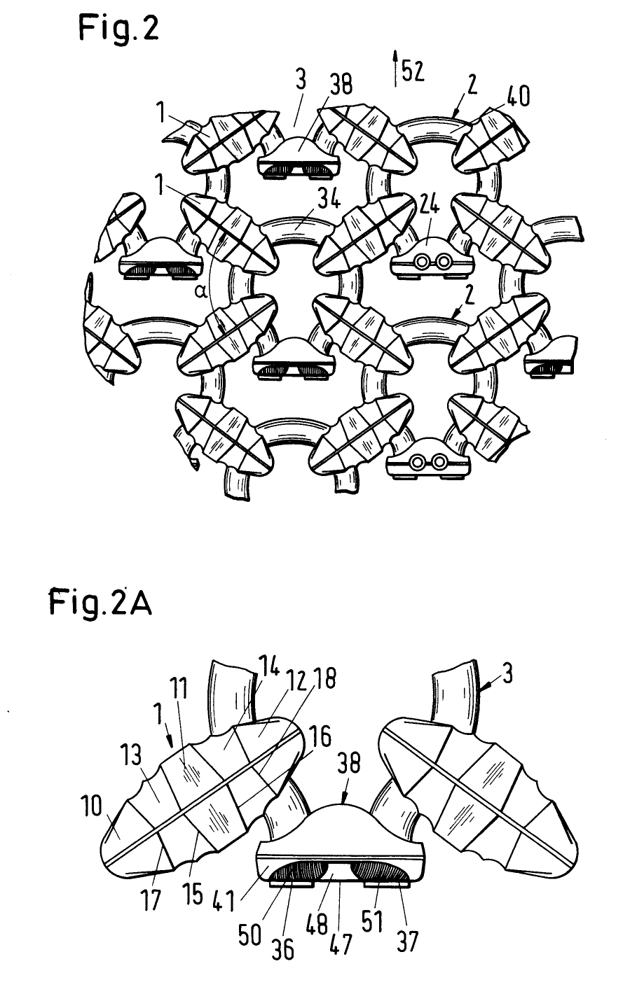

FIG. 2 in an illustration in accordance with FIG. 1 the protective tire chain after a certain time of use;

FIG. 2a in an enlarged illustration a part of the protective tire chain according to FIG. 2;

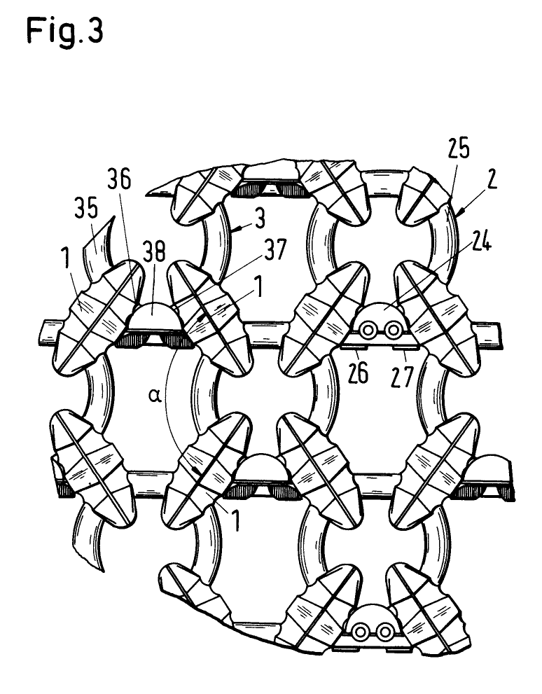

FIG. 3 the protective tire chain according to FIG. 1 whose chain members are in a final position after greater wear;

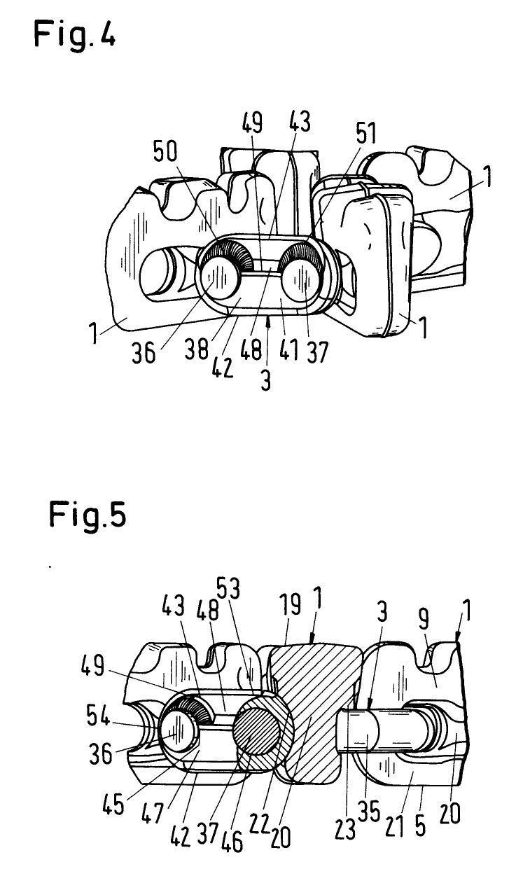

FIG. 4 in a perspective illustration four stay members that are inserted into a ring member according to the invention;

FIG. 5 a section view of a portion of the ring member according to the invention and a stay member of the chain assembly according to FIG. 4;

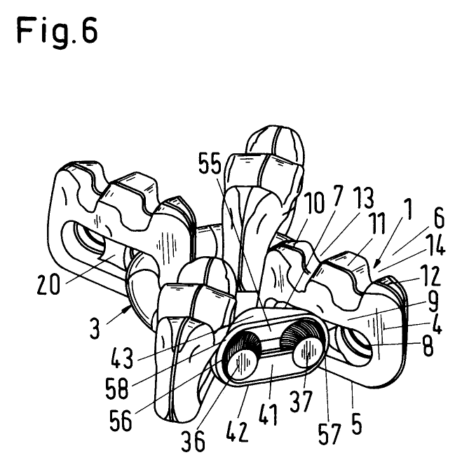

FIG. 6 in a perspective illustration the chain assembly according to FIG. 4;

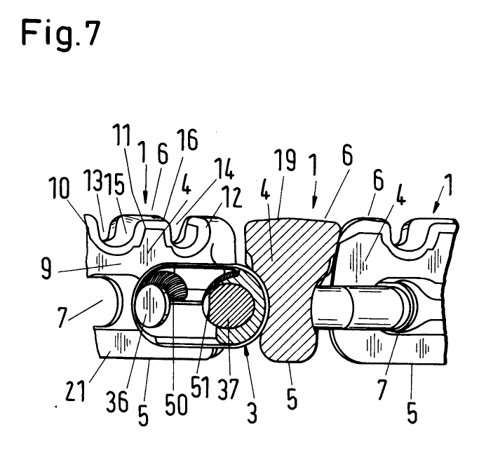

FIG. 7 a further section view of a portion of the ring member according to the invention and a stay member of the chain assembly according to FIG. 4;

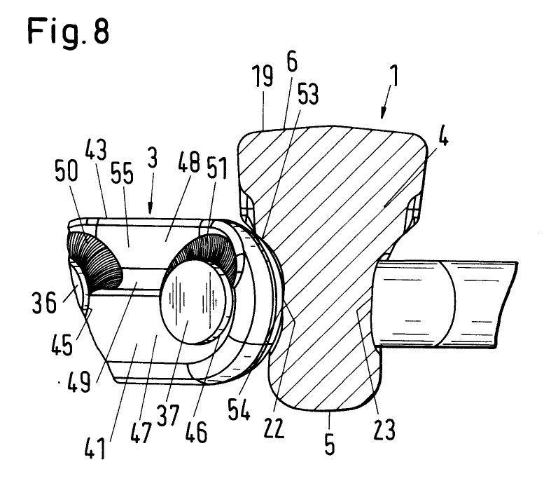

FIG. 8 an enlarged illustration of a detail of FIG. 7.

The protective tire chain serves for protecting the tires and has stay members 1 that are inserted into ring members 2, 3. The stay members 1 stand upright on the tire surface and connect neighboring ring members 2, 3 with one another. In the illustrated embodiment, four stay members 1 engage each ring member 2, 3.

The stay members 1 are configured identically and have a base member 4 (FIGS. 6 through 8) that has a tire contact surface 5 and an oppositely arranged wear side 6. The base member 4 is penetrated by two insertion openings 7 and 8 through which the ring members 2, 3 project. The insertion openings 7, 8 have a smaller spacing to the tire contact surface 5 than to the wear side 6. In this way, a sufficiently large wear volume for the stay members 1 is made available.

The base member part 9 provided with the wear side 6 widens in a direction away from the ends of the stay member such that it has at half the length its greatest width. In plan view onto the wear side 6 (FIG. 1) the stay member 1 has therefore an approximately diamond-shaped contour. The tire contact surface 5 is rounded in cross-section for protecting the tires (FIGS. 7 and 8).

For increasing traction, the stay member 1 has at its wear side 6 three projections 10 through 12 that are separated from one another by recesses 13, 14. The recesses 13, 14 extend about the entire width of the base member part 9.

As can be seen in FIGS. 1, 2a, and 7, the central projection 11 is delimited by roof-shaped lateral surfaces 15 and 16 forming a sidewall of the recesses 13, 14. The terminal projections 10 and 12 are configured mirror-symmetrical to one another and have also a roof-shaped or V-shaped lateral surface 17, 18, respectively. They form together with the opposed lateral surfaces 15, 16 the sidewalls of the recesses 13, 14. The lateral surfaces 17, 18 of the terminal projections 10, 12 are oriented toward the central projection 11 while the V-shaped lateral surfaces 15, 16 of the central projection 11 are oriented toward the terminal projections 10, 12. Because of the V-shaped lateral surfaces 15 to 18 the recesses 13, 14 widen outwardly beginning at half the width of the stay member 1, respectively. This contributes to preventing stones and the like, which would impair traction of the stay members 1, from being caught in the recesses 13, 14 during use of the protective tire chain.

As can be seen in FIGS. 5, 7, and 8, the end face 19 of the projections 10 through 12 in cross-section is V-shaped so that the projections at half the width of the stay member have their greatest height. This configuration contributes to the optimal traction of the stay member 1.

The two insertion openings 7, 8 of the stay member 1 are separated from one another by a web 20 that connects the base member part 21 having the tire contact surface 5 with the base member part 9 (FIG. 5) provided with the wear side 6 and the projections 10 through 12. The lateral surfaces 22, 23 of the web 20 viewed in cross-section are bent inwardly and extend in a curved fashion (FIGS. 5 and 8). The lateral surfaces 22, 23 of the web 20 are also curved in the longitudinal direction of the stay member 1. This configuration of the web 20 has the advantage that in an extreme position of the chain members (FIGS. 3 and 8) the ring members 2, 3 essentially rest areally against the lateral surfaces 22, 23 of the web 20 of the stay members 1 in a way to be described in the following. This contact situation is shown in an exemplary fashion in FIGS. 3, 5, 8.

The protective tire chain can of course also have stay members 1 that are designed differently. The illustrated and described configuration of the stay members 1 is to be understood only as an example. In this connection, it is also possible to provide differently designed stay members 1 within the protective tire chain.

Also, the ring members 2 within the protective tire chain are also embodied only in an exemplary fashion. The ring members 2 can also be circular ring members that can be combined with the ring members 2 according to the drawings within the assembly of the protective tire chain. The ring members 2 illustrated in FIGS. 1 to 8 have an advantage relative to circular ring members when after an extended period of use of the protective tire chain the chain members exhibit a certain wear and assume a position relative to one another as illustrated in FIG. 3. In this position, the stay members 1 rests against the closure parts 24 of the ring members 2.

The ring members 2 have an open ring body 25 whose ends 26, 27 are bent outwardly parallel to one another. Onto the straight ends 26, 27, the closure part 24 is pushed that has two through openings (not illustrated)for the ends 26, 27. For positional securing of the closure part 24 on the ring body ends 26, 27, two clamping pins 28, 29 are provided and inserted into corresponding openings 30, 31 of the closure part 24. The ring body ends 26, 27 are provided on their sides facing one another with part-circular recesses (not illustrated) that are engaged by the clamping pins 28, 29. In this way, the closure part 24 on the ring body ends 26, 27 are positive-lockingly secured. The closure part 24 has a central projection 33 that projects in the direction toward the ring opening 32; its end face is curved like an arc. The projection 33 projects so far in the direction of the ring opening 32 that it is positioned approximately at the level of the transition of the straight ring body ends 26, 27 into the arc-shaped part of the ring body 25.

The portion 34 of the ring body 25 opposite the closure part 24 is flattened so that it extends straight.

The ring members 3 have also an open ring body 35 whose ends 36, 37 are bent outwardly parallel to one another. On the straight ring body ends 36, 37 a closure part 38 is mounted with which the insertion opening 39 (FIG. 1) between the ring body ends 36, 37 is closed.

The ring body 35 has advantageously a round cross-section and is provided at the side opposite the closure part 38 with a flattened portion 40. In this area, the ring body 35 extends straight, viewed in the axial direction of the ring member 3 (FIG. 1).

The flattened portion 40, like the flattened portion 34, can be provided only at the outer side of the ring body 25, 35 that is facing the neighboring ring member 2, 3; the inner side of the ring member 25, 35 can have a constant radius. In the illustrated embodiment, the flattened portion 34, 40 is formed by an appropriately deformed section of the ring member 25, 35. The term flattened portion is to be understood not only as a plane configuration but also as a section that, for example, has a significantly greater radius of curvature than the remaining part of the ring body 25, 35.

The closure part 38 has a base body 41 (FIGS. 4 and 6) having parallel longitudinal sides 42, 43 that have a curved transition into one another. The two longitudinal sides 42, 43, viewed in the axial direction of the ring member 3, have a bell-shaped end face 44 (FIG. 1). At half its length, the closure part 38 thus has its greatest height.

The closure part 38 is provided with two through openings 45 and 46 (FIGS. 5 and 8) through which the ring body ends 36, 37 project. As can be seen in the drawings, the ring body ends 36, 37 project slightly past the end face 47 of the closure part 38 (FIG. 2a). They can also be positioned with their end faces in the end face 47 of the closure part 38.

In the plane end face 47 a recess 48 is provided which extends across half the width of the closure part 38 as well as across its length. The recess 48 is open toward the longitudinal side 43 and extends up to approximately half the diameter of the through openings 45, 46 (FIGS. 5 and 8). The recess 48 is delimited at the side opposite the longitudinal side 43 by a side wall 49 that adjoins perpendicularly the end face 47 of the closure part 38.

The closure part 38 is attached to the ring body ends 36, 37 by welding. The closure part 38 is pushed onto the ring body ends 36, 37. Subsequently, by means of the welding device a welding seam 50, 51 is applied from the longitudinal side 43. As shown in FIG. 4, the welding seam 50, 51 extends approximately across half the circumference of the ring body ends 36, 37. The welding seams 50, 51 extend from the side wall 49 to the bottom 55 as well as laterally to the outer sides 55, 57 of the ring body ends 36, 37 that are facing away from one another (FIG. 6). In the area of the outer sides 56, 57 the ring body ends 36, 37 are surrounded at a minimal spacing by a wall 58 that extends to the level of the side wall 49 of the recess 48. The wall 58 is optimally supported by the welding seams 50, 51. Even though the welding seams 50, 51 are not provided across the entire circumference of the ring body ends 36, 37, the closure part 38 is safely attached to the ring body ends 36, 37. As can be seen in FIG. 4, the welding seams 50, 51 can be sufficiently thick. The welding seams extend to the plane side wall 49 of the recess 48. Since the recess 48 is open toward the lateral surface 43, the welding seams can be applied in a simple way. In particular, the welding process can be carried out while the ring member 3 is horizontally positioned. In this way, a simple and fast assembly of the protective tire chain is possible. For example, the welding process can be performed automatically by a welding robot. In the mounted position, the welding seams 50, 51 are covered relative to the tire by the longitudinal side 42.

FIG. 1 shows the protective tire chain when it is new. The chain members 1 to 3 have not yet been used. The protective tire chain is tensioned in its longitudinal direction 52 such that the longitudinal axes of neighboring stay members 1 inserted into a common ring member 2, 3 have an angle of approximately 50 degrees. This angular position is achieved when the protective tire chain is new and is tensioned so much in the longitudinal direction 52 that the adjacently positioned ring members 2, 3 contact one another or almost contact one another. In order to prevent in this position an impermissibly high loading of the ring members 2, 3, the ring members are provided with the flattened portions 34, 40 on which the closure parts 24, 38 with their end faces rest. The ring body portions 34, 40 can be flattened at their outer sides so that they rest flat against the end faces of the closure parts. In this state of the protective tire chain, the stay members 1 have a spacing from one another. As a result of the flattened portions 34, 40 of the ring members 2, 3 the stay members 1 can have a relatively small pitch angle so that the stay members 1 only have a relatively small angle relative to the longitudinal chain direction.

In this way, the tilting load that is acting on the stay members 1 is reduced. The stay members 1 must not mandatorily have the afore described profiling in the form of the projections 10 through 12 on their wear side 6. The profiling of the described stay members 1 increases advantageously traction.

When using the protective tire chain, the wear members 1 to 3 will wear. This has the result that the angle between the neighboring stay members 1 becomes greater. In FIG. 2, this angle is for example approximately 70 degrees. The ring members 2, 3 that neighbor one another have now a spacing from one another, i.e., the wear parts 24, 38 rest no longer against the flattened sections 34, 40 of the neighboring ring members 2, 3, respectively. The pitch angle of the stay members 1 is still sufficiently small.

FIG. 3 shows the protective tire chain in a position in which the stay members 1 rest against the closure parts 24, 38 of the ring members 2, 3. This is the result of the increasing wear of the chain members 1 to 3. The longitudinal axis of the neighboring stay members 1 are positioned at an angle that is greater than 100 degrees. In order to prevent damage of the chain members 1 to 3, the protective tire chain in this state must be tensioned anew in order to obtain at least the chain member position according to FIG. 2.

The closure parts 24, 38 are formed substantially identically with regard to their contour shape. Their longitudinal sides 42, 43 have an arc-shaped transition into one another. This arc-shaped transition is matched to the lateral surfaces 22, 23 of the web 20 between the insertion openings 7, 8 (FIG. 5) in such a way that the ring members 1 with the corresponding lateral surfaces 22, 23 of their stays 20 rest substantially areally against the curved transition surfaces 53, 54 (FIGS. 5 and 8) between the longitudinal sides 42, 43 of the closure parts 24, 38. In this way, the ring members 2, 3, as shown in FIG. 3, are centered by means of the stay members 1 resting against the dosure parts 24, 38. Accordingly, the loads acting on the ring members 2, 3 are minimized. Because of this contact of the stay members 1 on the closure parts 24, 38, the parts of the stay members projecting into the ring members 2, 3 do not reach the area of the transition where the ring bodies 25, 35 pass into the bent ends 26, 27; 36, 37.

The described ring members 2 enable a configuration weldable on one side as a result of their recess 48 provided in the closure part 38 and open at one side. During manufacture of the protective tire chain, the ring member 3 or the chain must no longer be turned for the welding process. After final assembly of the protective tire chain with the described chain members 1 to 3, a final heat treatment is no longer required. The chain members 1 to 3 are already finish-machined and heat-treated prior to final assembly. In this way, an inexpensive and simple manufacture of the protective tire chain is possible. Since the ring members 2, 3 have the flattened portions 34, 40, the stay members 1 can be positioned optimally for minimal tilting loads. The flattened portions can be provided on the ring members 2,3 without problems and require no complex and expensive manufacture of these ring members.

The ring members 2, 3 are arranged advantageously within the chain assembly such that the closure parts 24, 38 are positioned transversely to the longitudinal chain direction 52.

In deviation from the illustrated embodiment, the protective tire chain can be provided only with ring members 3 in addition to stay members 1. Since the closure part 38 is welded to the ring body ends 36, 37, there is no risk that the closure parts accidentally become detached from the ring body.

What is claimed is:

1.-21. (canceled)

22. A ring member for a tire chain, the ring member comprising a ring body having at least one flattened portion deviating from a circular shape at an outer side of the ring member.

23. The ring member according to claim 22, wherein the at least one flattened portion is plane.

24. The ring member according to claim 22, wherein the at least one flattened portion is a deformed section of the ring body.

25. The ring member according to claim 22, wherein the ring body has ring body ends that are bent and delimit an insertion opening, wherein the at least one flattened portion is positioned opposite the ring body ends.

26. The ring member according to claim 25, further comprising a closure part seated on the ring body ends, wherein a length of the at least one flattened portion corresponds at most to a length of the closure part.

27. The ring member according to claim 26, wherein the at least one flattened portion is matched at least partially to a shape of an end face of the closure part.

28. The ring member according to claim 26, wherein the closure part is partially open in a direction transversely to a longitudinal direction of the ring body ends.

29. The ring member according to claim 28, wherein the closure part has a recess open toward a longitudinal side of the closure part.

30. The ring member according to claim 29, wherein the closure part has through openings through which the ring body ends are pushed, wherein the recess extends approximately to a level of half a diameter of the through openings.

31. The ring member according to claim 29, wherein at the level of the through openings the recess is delimited by a side wall end face that extends to the end face of the closure part.

32. The ring member according to claim 31, wherein the end face of the closure part is at least partially matched to a shape of the at least one flattened portion of the ring body.

33. The ring member according to claim 22, further comprising a closure part, wherein the ring body has ring body ends that are bent and delimit an insertion opening, wherein the closure part is seated on the ring body ends, wherein the ring body ends and the closure part are connected by a welding seam extending only about a portion of a circumference of the ring body ends.

34. The ring member according to claim 33, wherein the welding seam is positioned in a recess of the dosure part.

35. A tire chain comprising:
ring members each comprising a ring body having at least one flattened portion deviating from a circular shape at an outer side of the ring member;
stay members engaging the ring members;
wherein the ring members are arranged such that the at least one flattened portion, respectively, extends at least approximately in a longitudinal chain direction.

36. The tire chain according to claim 35, wherein the stay members engage the ring members in an area outside of the at least one flattened portion, respectively.

37. The tire chain according to claim 35, wherein the stay members have insertion openings that are separated from one another by a web.

38. The tire chain according to claim 37, wherein the ring members each have a closure part, wherein the web has an outer shape and the closure part has an outer shape, wherein the outer shapes of the web and of the closure part are matched to one another such that, in an end position of the tire chain, the web and the closure part rest approximately areally against one another.

39. The tire chain according to claim 38, wherein the web has inwardly curved lateral surfaces and the closure part has outwardly curved surfaces.

40. The tire chain according to claim 38, wherein the closure part is centered in the end position between two of the stay members.

41. A method for manufacturing a tire chain according claim 35, the method comprising the steps of:
inserting stay members through insertion openings of the ring member;
attaching a closure part to ring body ends of the ring member;
positioning a welding device at the closure part transversely to a side of the closure part having a recess;
welding the ring body ends to the closure part in the recess while the ring member is in a horizontal position.

42. The method according to claim 41, wherein a welding seam connecting the ring body ends to the closure part that extends only about a portion of a circumference of the ring body ends.
